(19) United States
(12) Patent Application Publication
(10) Pub. No.: US 2003/0044743 A1
(43) Pub. Date: Mar. 6, 2003

(54) Furnace assembly for heating an optical waveguide preform

(76) Inventors: Dana C. Bookbinder, Corning, NY (US); Steven A. Dunwoody, Castle Hayne, NC (US); Richard M. Fiacco, Corning, NY (US); Eric M. Johnson, Wilmington, NC (US)

Correspondence Address: MYERS BIGEL SIBLEY & SAJOVEC, PO BOX 37428, RALEIGH, NC, 27627, US

(21) Appl. No.: 09/941,383

(22) Filed: Aug. 28, 2001

(51) Int. Cl. F27D 15/00; C03B 37/01

(52) U.S. Cl. 432/86

(57) ABSTRACT

A furnace assembly for heating an optical waveguide preform includes a furnace. The furnace includes a muffle and a heating device. The muffle defines a furnace passage. The furnace passage has a length extending from a first end to a second end. The heating device is operative to heat the furnace passage. A process gas supply provides a process gas to the furnace passage. A handle is disposed in the furnace passage and is adapted to hold the waveguide preform. A flow shield is positioned between the first and second ends and extends across the furnace passage between the handle and the muffle. The flow shield is arranged and configured to restrict flow of the process gas from the first end to the second end of the furnace passage.

### FIELD OF THE INVENTION

The present invention relates to furnaces for heating an optical waveguide preform, and, more particularly, to such a furnace which uses a flow of processing gas.

### BACKGROUND OF THE INVENTION

Inert gases such as helium (He) are used in large volumes in the manufacture of optical fiber or waveguides. For example, a soot or glass preform may be placed in a consolidation furnace having a muffle and a plate covering an end of the muffle, the plate having a hole or other leak paths through which ambient air may enter the muffle. A flow of He may be passed through the furnace and about the preform to eliminate or reduce the entry of air into the furnace where it may otherwise cause defects in the preform or damage the furnace. High flow rates of He may be required to adequately seal the furnace from air. Similarly, during preform drying operations, a relatively high rate of flow of chlorine gas (Cl₂) may be used to prevent or reduce the introduction of air into the drying furnace. He and Cl₂ may be costly. Moreover, the He or Cl₂ exiting the furnace typically must be treated for pollution abatement, which may substantially increase the costs of manufacturing fiber.

### SUMMARY OF THE INVENTION

According to embodiments of the present invention, a furnace assembly for heating an optical waveguide preform includes a furnace. The furnace includes a muffle and a heating device. The muffle defines a furnace passage, the passage having a length extending from a first end to a second end. The heating device is operative to heat the furnace passage. A process gas supply provides a process gas to the furnace passage. A handle is disposed in the furnace passage and is adapted to hold the waveguide preform. A flow shield is positioned between the first and second ends and extends across the furnace passage between the handle and the muffle. The flow shield is arranged and configured to restrict flow of the process gas from the first end to the second end of the furnace passage.

The flow shield may serve to reduce or minimize the amount of process gases needed. Further, the flow shield may reduce or minimize the detrimental effects that O₂, H₂, H₂O, N₂, CO₂ and other gases may have on the preform and resultant fibers drawn therefrom.

According to further embodiments of the present invention, a furnace assembly adapted to heat an optical fiber preform includes a muffle tube defining a furnace passage. The passage includes a length extending from a first end to a second end. A process gas supply is adapted to supply a process gas in the passage directed from the first end to the second end. A handle is adapted to suspend the preform within the passage. A flow shield is positioned in the passage between the preform and the second end and extends between the handle and the muffle tube. The flow shield is configured to enable restriction of flow of the process gas.

According to further embodiments of the present invention, a furnace assembly adapted to heat an optical fiber preform includes a muffle tube including a passage. A top plate is mounted on an end of the tube. A gas supply is provided for supplying process gas to the passage. A handle traverses the top plate and is adapted to suspend the preform in the passage. A flow shield is positioned in the passage between the preform and the top plate. The flow shield is configured to enable restriction of the gas.

According to further embodiments of the present invention, a flow restrictor assembly for an optical fiber furnace adapted to heat an optical fiber preform includes a top plate having a passage of a first dimension formed therethrough. At least one solid flow restrictor having a hole of a second dimension formed therethrough is provided. A handle is inserted through the passage and the hole. The handle is adapted to suspend the preform. The first dimension is larger than the second dimension.

According to method embodiments of the present invention, a method of manufacturing an optical fiber preform includes flowing a process gas in a furnace passage of a muffle tube from a first end to a second end. The furnace passage has the optical fiber preform mounted therein. Flow of the process gas is restricted using a flow shield positioned in the passage between the preform and the second end and extending between a handle and the muffle tube.

Objects of the present invention will be appreciated by those of ordinary skill in the art from a reading of the figures and the detailed description of the preferred embodiments which follow, such description being merely illustrative of the present invention.

### BRIEF DESCRIPTION OF THE DRAWINGS

FIG. 1 is a schematic, fragmentary view of a furnace assembly according to embodiments of the present invention;

FIG. 2 is a schematic, fragmentary view of a furnace assembly according to further embodiments of the present invention;

FIG. 3 is a schematic, fragmentary view of a furnace assembly according to further embodiments of the present invention;

FIG. 4 is a schematic, fragmentary view of a furnace assembly according to further embodiments of the present invention;

FIG. 5 is a schematic, fragmentary view of a furnace assembly according to further embodiments of the present invention;

FIG. 6 is a schematic, fragmentary view of a furnace assembly according to further embodiments of the present invention;

FIG. 7 is a schematic, fragmentary view of a furnace assembly according to further embodiments of the present invention;

FIG. 8 is a schematic, fragmentary view of a furnace assembly according to further embodiments of the present invention; and

FIG. 9 is a schematic, fragmentary view of a furnace assembly according to further embodiments of the present invention.

### DETAILED DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

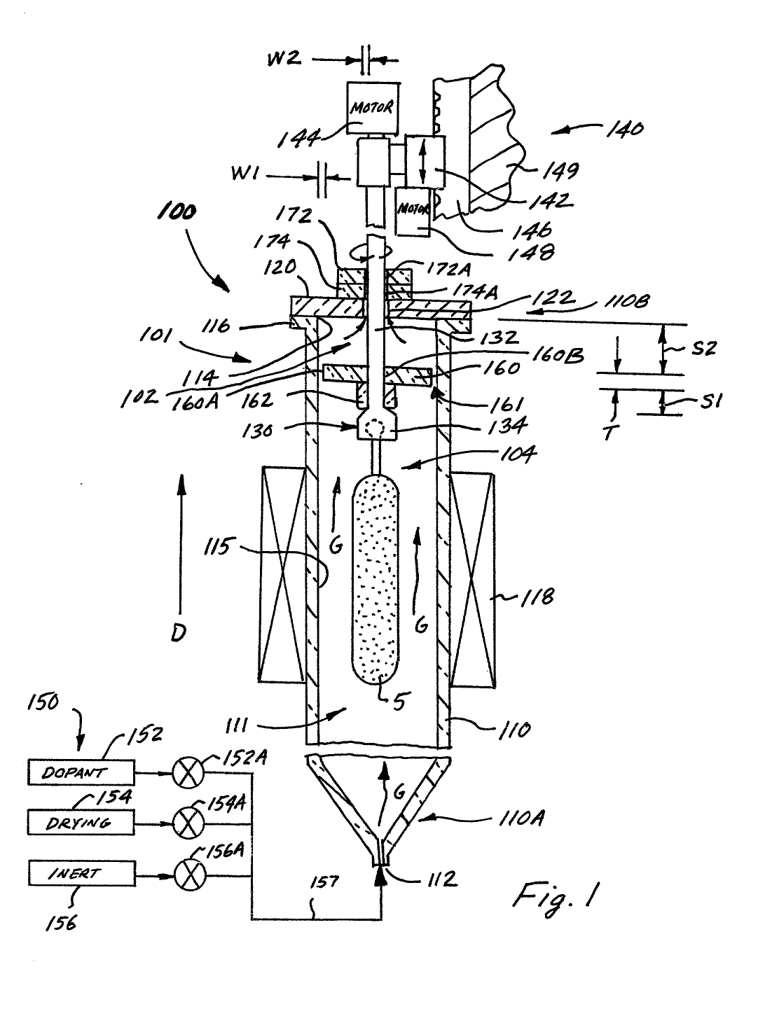

With reference to FIG. 1, a furnace assembly 100 according to embodiments of the present invention is shown therein. The furnace assembly 100 is adapted to heat an optical waveguide preform 5 such as the soot preform shown. The furnace assembly 100 is adapted to prevent or reduce exposure of the preform 5 to ambient air while allowing the use of a reduced flow rate of process gas.

The preform 5 may be a soot preform (as illustrated) or a glass preform which may be formed from a soot preform. The soot preform may be formed using any suitable method, such as chemical vapor deposition (CVD). Suitable methods for forming soot preforms are known to those of skill in the art and include outside vapor deposition (OVD). For example, U.S. Pat. No. 4,629,485, the disclosure of which is hereby incorporated herein by reference, discloses suitable methods and apparatus for forming a soot preform. The soot preform 5 may be formed of pure silica or may be formed of doped silica (for example, silica doped with germania, fluorine, chlorine and/or phosphorus). The preform 5 may include a passage extending the full length thereof from which a mandrel of the chemical vapor deposition apparatus has been removed.

The furnace assembly 100 includes a furnace 101, a process gas supply system 150 and a preform positioning and rotating system 140. The furnace 101 includes a tubular muffle 110 having an inlet opening 112, an outlet opening 114 and an annular flange 116. The muffle 110 defines a furnace passage 111 having a lower end 110A and an upper end 110B. A top plate 120 covers the outlet opening 114 and interfaces with the flange 116. The top plate 120 has a central opening 122. The muffle 110 and top plate 120 are preferably formed of fused silica, fused quartz, ceramic, ceramic coated fused silica, or ceramic coated fused quartz.

A heating device 118 is positioned about the muffle 110. The heating device 118 may be, for example, a resistance coil or element operable to heat the muffle 110. Optionally, the heating device 118 may be an induction coil and an element including a susceptor surrounding the muffle 110.

The positioning and rotating system 140 includes a handle 130. The handle shaft or body 130 includes a handle body 132 extending through the opening 122 and into the passage 111 through the opening 114. A coupling portion 134 is formed on the lower end of the handle body 132 and is arranged and configured to hold and suspend the preform 5. The handle body 132 and the coupling portion 134 are preferably formed of fused silica, fused quartz, ceramic, ceramic coated fused silica, or ceramic coated fused quartz.

The handle 130 is connected to a shuttle 142 on a rail 146 which is in turn mounted on a stationary support 149. A motor 148 is operable to move the shuttle 142 up and down along the rail 146 and to thereby raise and lower the handle 130 and the preform 5 with respect to the muffle 110 and the top plate 120. A motor 144 is operable to rotate the handle 130 and to thereby rotate the preform 5 with respect to the muffle 110 and the top plate 120.

The process gas supply system 150 includes a dopant gas supply 152, a drying gas supply 154 and an inert gas supply 156. Valves 152A, 154A and 156A are provided to control flow of the gases from the supplies 152, 154 and 156, respectively, into a feed line 157. The process gas G from the feed line 157 enters the passage 111 through the inlet opening 112 and flows upwardly in the direction D from the end 110A to the end 110B about the preform 5. As discussed in more detail below, the process gas G ultimately exits the furnace passage 111 through the opening 122 and/or gaps between the top plate 120 and the flange 116. Depending on the selected gas and other process parameters, the process gas that exits the passage 111 may be modified. For example, if a dopant gas is used, portions of the dopant may be retained in the preform 5. Similarly, if a drying gas is used, hydroxyl ions and other constituents may be exhausted with the process gas G.

In a first embodiment, a flow shield 160 is mounted on the handle body 132 in the passage 111 between the preform 5 and the upper end opening 114. The periphery defined by the outer peripheral wall 160A of the flow shield 160 preferably has a shape that is complimentary to the shape of the passage 111. More preferably, the flow shield 160 is a circular disc and the passage 111 and the peripheral wall 160A are each cylindrical.

The handle body 132 extends through a central hole 160B in the flow shield 160. A cylindrical spacer 162 spaces the flow shield 160 from the coupling portion 134. Optionally, the flow shield 160 may be secured to the handle body 132 (e.g., by frictional fit or fusing).

The peripheral wall 160A and the adjacent portion of the inner surface 115 of the muffle 110 define an annular restrictive flow passage 161 therebetween and surrounding the flow shield 160. The flow shield 160 effectively divides the passage 111 into an upper isolation chamber 102 above the flow shield 160 and a lower process chamber 104 below the flow shield 160. The chambers 102 and 104 are fluidly connected by the restrictive flow passage 161.

Preferably, the flow shield 160 and the spacer 162 are formed of fused quartz, fused silicon, ceramic or silicon carbide. Preferably, the thickness T of the flow shield 160 is greater than about 6 mm and, more preferably, greater than about 38 mm. The height S1 of the spacer 162 is preferably between about 50 mm and 0.75 meter. Preferably, the peripheral wall 160A is substantially fully vertically oriented. Preferably, the gap width W1 of the restrictive flow passage 161 is no more than about 25 mm. More preferably, the gap with W1 is between about 2.5 mm and 12.5 mm. The height S2 of the upper chamber 102 is preferably between about 25 mm and 1 meter when the preform 5 is in the desired position in the furnace 101.

A plurality of washers 172, 174 are positioned over the opening 122 with the handle body 132 extending through central openings 172A, 174A formed therein. Preferably, the openings 172A, 174A are sized to fit loosely (slip fit) against the handle body 132. The washers 172, 174 are preferably formed of solid fused silica, fused quartz, ceramic, or silicon carbide.

The furnace assembly 100 may be used in the following manner. The preform 5 is suspended from the coupling portion 134. The preform 5, the handle 130, the flow shield 160 and the spacer 162 are lowered into the passage 111 using the motor 148. The preform 5 is lowered until the top plate 120 comes to rest on the flange 116 as shown in FIG. 1.

The selected process gas G is introduced from the appropriate supply or supplies 152, 154, 156 by opening the associated valve or valves 152A, 154A, 156A. For example, if the intended process is a doping process, the dopant supply valve 152A is opened. Suitable dopant gases include Cl₂, SiF₄, CF₄, SF₆, NF₃, GeCl₄, SiCl₄, POCl₃, BCl₃, BF₃, PCl₃, C₂F₆, and CO, as well as mixtures thereof. Alternatively, if a drying process is desired, the valve 154A is opened. Suitable drying gases include Cl₂, SiF₄, CF₄, C₂F₆, SF₆, NF₃, SiCl₄, GeCl₄, POCl₃, BCl₃ and BF₃. Where an inert gas is desired (for example, during a sintering process), the valve 156A is opened. Suitable inert gases include He, Ar, N₂ and Ne.

Additionally, the heating device 118 is operated to heat the muffle 110 to the desired temperature. The handle 130 may be rotated by the motor 144. The preform 5, the flow shield 150, the spacer 162, and the washers 172, 174 will rotate with the handle 130.

The process gas G enters the muffle 110 through the inlet opening 112 and passes in the direction D around the preform 5 up to the flow shield 160. The process gas 5 then flows through the restrictive flow passage 161 and into the upper chamber 102. Finally the process gas G exits the furnace passage 111 through the opening 122 and/or the interface between the flange 116 and the top plate 120. Notably, the washers 172, 174 and the mating surfaces of the top plate 120 and the flange 116 further restrict flow of the process gas G out of the furnace passage 111. The washers 172, 174 allow suitable clearance between the top plate 120 and the handle 132.

The flow of the process gas G out of the furnace passage 111 as described above serves to prevent or inhibit entry of air through the interface between the top plate 120 and the flange 116 and through the opening 122. Moreover, the restrictive flow passage 161 and the process gas G flowing upwardly through the restrictive flow passage 161 prevent or inhibit any air which does enter the upper, isolation chamber 102 from entering the lower chamber 104 where it might otherwise contaminate the preform 5 or the lower portion of the muffle 110.

Preferably, the flow rate of the process gas G through the furnace passage 111 is less than 30 slpm (standard liters per minute). More preferably, the flow rate of the process gas G through the passage 111 is less than 20 slpm. Most preferably, the flow rate of the process gas G through the furnace passage 111 is less than 10 slpm.

As noted above, the flow shield 160 and the spacer 162 are preferably formed of fused silica, fused quartz, ceramic, ceramic coated fused silica, or ceramic coated fused quartz. As such, they do not contribute to contamination of the preform 5 when heated to operating temperatures in the range of about 650 to 2100° C. and, more particularly, in the range of 900 to 1600° C. The spacer 162 spaces the flow shield 160 from the preform 5 so that heat reflected downwardly from the flow shield 160 does not cause nonuniform heating of the upper portion of the preform 5.

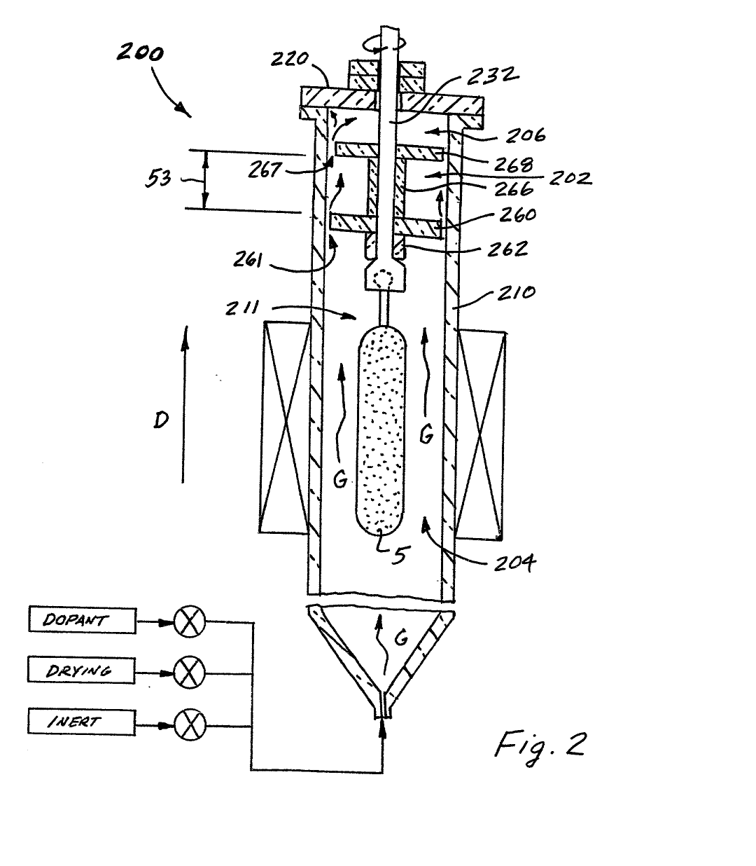

With reference to FIG. 2, a furnace assembly 200 according to further embodiments of the present invention is shown therein. The furnace assembly 200 corresponds to the furnace assembly 100 except as follows. A flow shield 260 and a spacer 262 corresponding to the flow shield 160 and the spacer 162 are provided, the flow shield 260 forming a restrictive flow passage 261 with the muffle 210. Additionally, a second cylindrical spacer 266 extends upwardly up from the flow shield 260 and about the handle body 232. A second flow shield 268 is mounted on the spacer 266. The outer peripheral wall of the second flow shield 268 defines a second restrictive flow passage 267 with the adjacent portion of the inner surface of the muffle 210. In use, the process gas G flows up the passage 211 in the direction D, through the restrictive flow passage 261, into the chamber 202 between the flow shields 260 and 268, through the restrictive flow passage 267, into the chamber 206 between the flow shield 268 and the top plate 220, and finally out of the passage 211 in the manner described above. Accordingly, the face shield 268 and the upper chamber 206 provide further barriers to entry of air into the lower chamber 204.

Preferably, the gap width of the restrictive flow passage 267 is the same as described above with regard to the restrictive flow passage 261. The flow shield 268 may be formed in the same manner as described above with regard to the flow shield 160. The spacer 266 is preferably formed of fused silica, fused quartz, ceramic, ceramic coated fused silica, or ceramic coated fused quartz, as well as combinations thereof. Preferably, the spacing S3 between the flow shields 260, 268 is between about 25 mm and 0.5 meter.

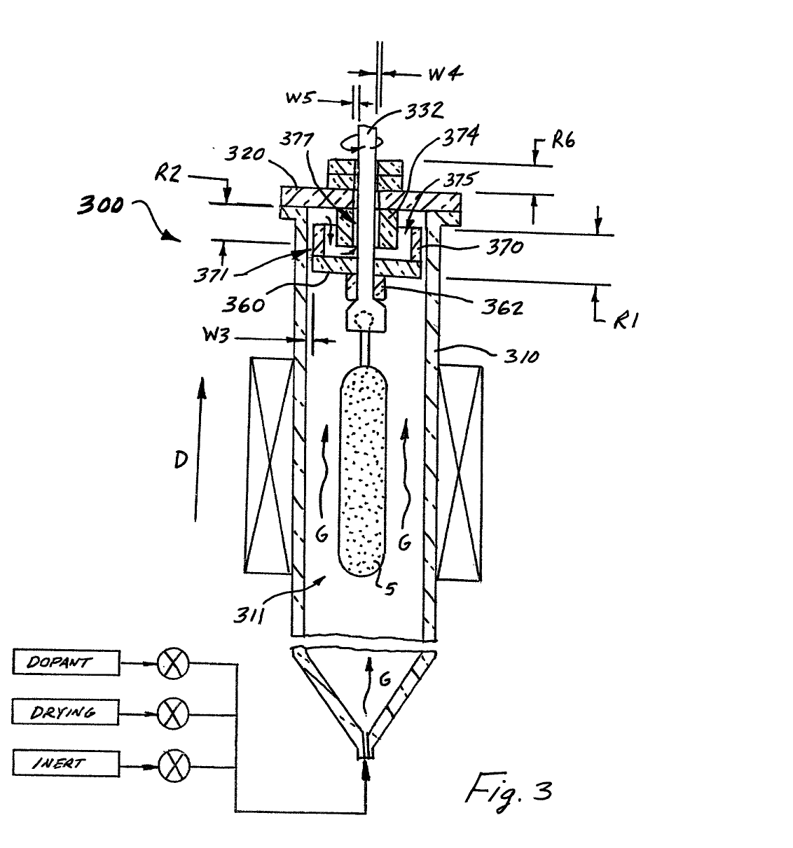

With reference to FIG. 3, a furnace assembly 300 according to further embodiments of the present invention as shown therein. The furnace assembly 300 corresponds to the furnace assembly 100 except as follows. A flow shield 360 and a spacer 362 corresponding to the flow shield 160 and the spacer 162 are provided. A cylindrical shield collar 370 is secured to and extends upwardly from the flow shield 360. The outer peripheral wall of the flow shield 360 and the outer surface of the collar 370 define a lengthwise restrictive flow passage 371 with the adjacent portion of the inner surface of the muffle 310. Additionally, a second cylindrical shield collar 374 is secured to and extends downwardly from the lower surface of the top plate 320 and into the collar 370. The inner surface of the collar 374 defines a second lengthwise restrictive flow passage 377 with the adjacent portion of the outer surface of the handle body 332. The flow shield 360, the collar 370 and the collar 374 define a connecting passage 375 therebetween.

In use, the process gas G flows up the passage 311 in the direction D and through the restrictive flow passage 371. While a portion of the process gas G may exit the muffle 310 through the interface between the top plate 320 and the muffle 310, a remaining portion of the process gas G will pass through the connecting passage 375 and the restrictive flow passage 377.

The collars 370 and 374 are preferably formed of fused silica, fused quartz, ceramic, ceramic coated fused silica, or ceramic coated fused quartz, or combinations thereof. The gap width W3 of the restrictive flow passage 371 is preferably between about 2.5 mm and 12.5 and, more preferably, no greater than 25 mm. The length R1 of the restrictive flow passage 371 is preferably between 25 mm and 0.5 meter. The spacing W4 between the washers 372, 374, and the handle 332 is preferably between about 0.25 mm and 2 mm. The length of the restrictive flow passage defined between the washers 372, 374, and the handle 332 is preferably between about 0.25 mm and 5.0 mm. The gap width W5 of the restrictive flow passage 377 is preferably between 1 mm and 20 mm. The length R2 of the restrictive flow passage 377 is preferably between 25 mm and 0.25 meter.

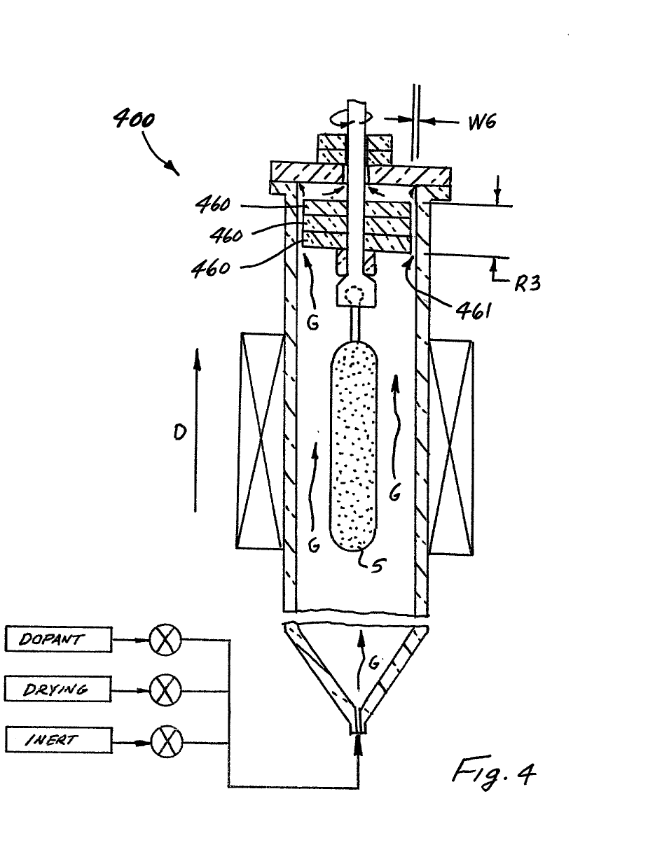

With reference to FIG. 4, a furnace assembly 400 according to further embodiments of the present invention is shown therein. The furnace assembly 400 corresponds to the furnace assembly 100 except as follows. The furnace assembly 400 includes three flow shields 460, each corresponding to the flow shield 160, in a stacked arrangement. The flow shields 460 may be fused or otherwise affixed to one another. The outer peripheral walls of the flow shields 160 in combination form a lengthwise extending restrictive flow passage 461. The gap width W6 of the restrictive flow passage 461 is preferably between about 2.5 mm and 12.5 mm and no greater than 25 mm. The length R3 of the restrictive flow passage 461 is preferably between about 18 mm and 125 mm.

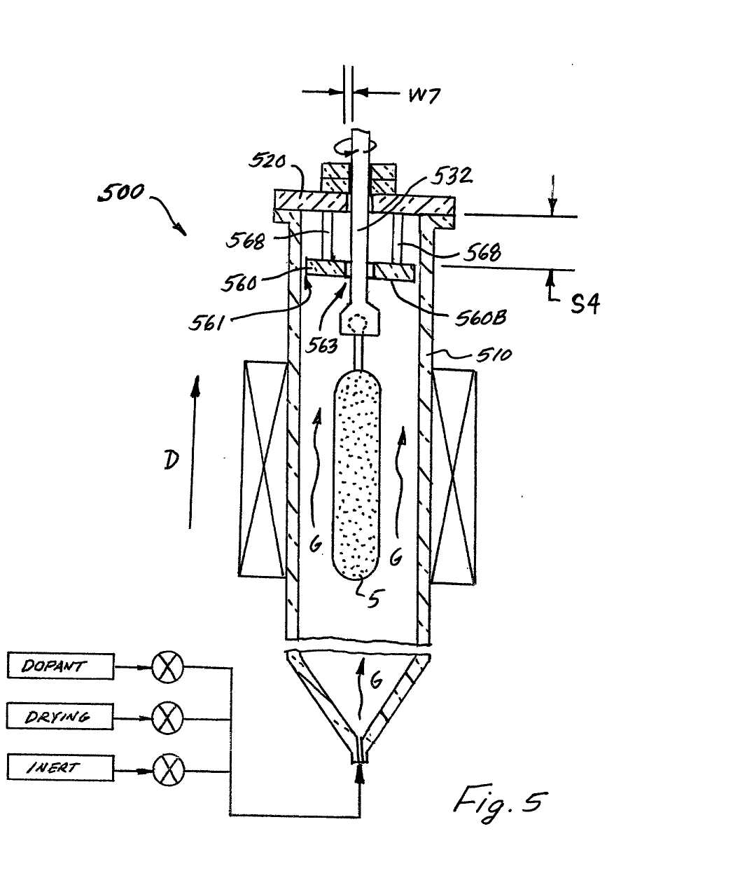

With reference to FIG. 5, a furnace assembly 500 according to further embodiments of the present invention is shown therein. The furnace assembly 500 corresponds to the furnace assembly 100 except as follows. The furnace assembly 500 includes a flow shield 560 corresponding to the flow shield 160 except that the central opening 560A of the flow shield 560 is enlarged to provide clearance for the handle body 532 and to define a restrictive flow passage 563. Preferably, the gap width W7 of the restrictive flow passage 563 is between about 1 mm and 20 mm.

The flow shield 560 is suspended from the top plate 520 by connecting members 568 which are secured to each of the flow shield 560 and the top plate 520, for example by fusing. Preferably, the connecting members 568 are rod shaped. Alternatively, the connecting member may be a tube with holes formed therein. The connecting members 568 are preferably formed of fused silica, fused quartz, ceramic, ceramic coated fused silica, or ceramic coated fused quartz. The spacing S4 between the flow shield 560 and the top plate 520 is preferably between about 125 mm and 0.6 meter.

The outer peripheral wall of the flow shield 560 defines a restrictive flow passage 561 with the inner surface of the muffle 510. Preferably, the restrictive flow passage 561 has a gap width the same as described above with regard to the restrictive flow passage 161.

The furnace assembly 500 may be operated in the same manner as described above with regard to the furnace assembly 100, except that the flow shield 560 is not raised and lowered with the preform 5. Additionally, the process gas G may flow through the restrictive flow passage 563. The furnace assembly 500 may be preferred where it is desired to reduce the risk of impact between the flow shield 560 and the muffle 510.

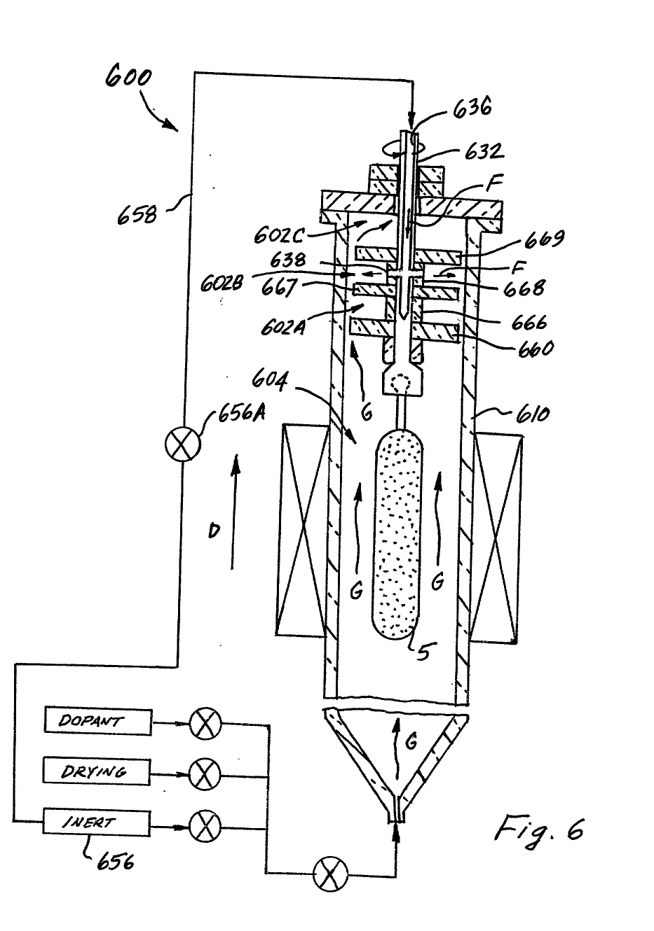

With reference to FIG. 6, a furnace assembly 600 according to further embodiments of the present invention is shown therein. The furnace assembly 600 corresponds to the furnace assembly 100 except as follows. Three flow shields 660, 667, 669 corresponding to the flow shield 160 are stacked with spacers 666 and 668 interposed therebetween. The flow shields 660, 667 and 669 define a lower chamber 604 and upper chambers 602A, 602B and 602C. The flow shields 660, 667, 669 define restrictive flow passages with the muffle 610 in the same manner as described above with regard to the flow shield 160.

The handle body 632 includes a handle passage 636 formed therein and fluidly communicating with radially extending gas openings 638. The gas openings 638 are positioned between the flow shields 667 and 669. A supply of inert gas 656 is fluidly connected to the handle passage 636 by a line 658. By operation of the valve 656A, inert gas F may be introduced into the handle passage 636 such that the inert gas exits through the gas openings 638 and into the chamber 602B. The inert gas F thereafter flows up into the chamber 602C and out of the muffle 610 with the process gas G. In this manner, the inert gas serves as a purge gas to provide an additional barrier to entry of air.

Preferably, the inert gas F is Ar, He, or N₂. Alternatively, the same gas (and gas supply) as used for the process gas G may be used for the gas F supplied through the handle passage 636. Alternatively, the inert gas may be supplied into the chamber 602C through a hole in the top plate or a similar passage.

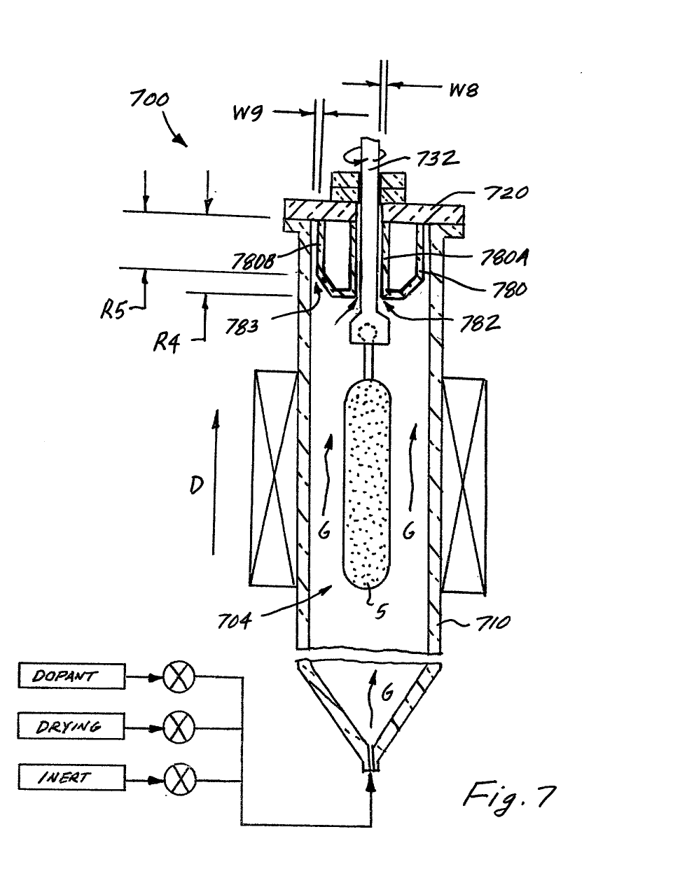

With reference to FIG. 7, a furnace assembly 700 according to further embodiments of the present invention is shown therein. The furnace assembly 700 corresponds to the furnace assembly 100 except as follows. In the furnace assembly 700, the flow shield 160 and the spacer 162 are omitted. A toroidal flow shield collar 780 is secured to and depends from the top plate 720 and surrounds the handle body 732. An inner surface 780A of the flow shield collar 780 defines a first restrictive flow passage 782 with the handle body 732. An outer surface 780B of the collar 780 defines a second restrictive flow passage 783 with the inner surface of the muffle 710. In use, the flow of the process gas G out of the muffle 710 is restricted by the restrictive flow passages 782 and 783, and, likewise, entry of air into the lower chamber 704 is restricted.

The gap width W8 of the restrictive flow passage 782 is preferably between about 1 mm and 20 mm. The length R4 of the restrictive flow passage 782 is preferably between about 25 mm and 0.3 meter. The gap width W9 of the restrictive flow passage 783 is preferably between about 2.5 mm and 12.5 mm and no greater than 25 mm. The length R5 of the restrictive flow passage 783 is preferably between about 75 mm and 0.25 meter.

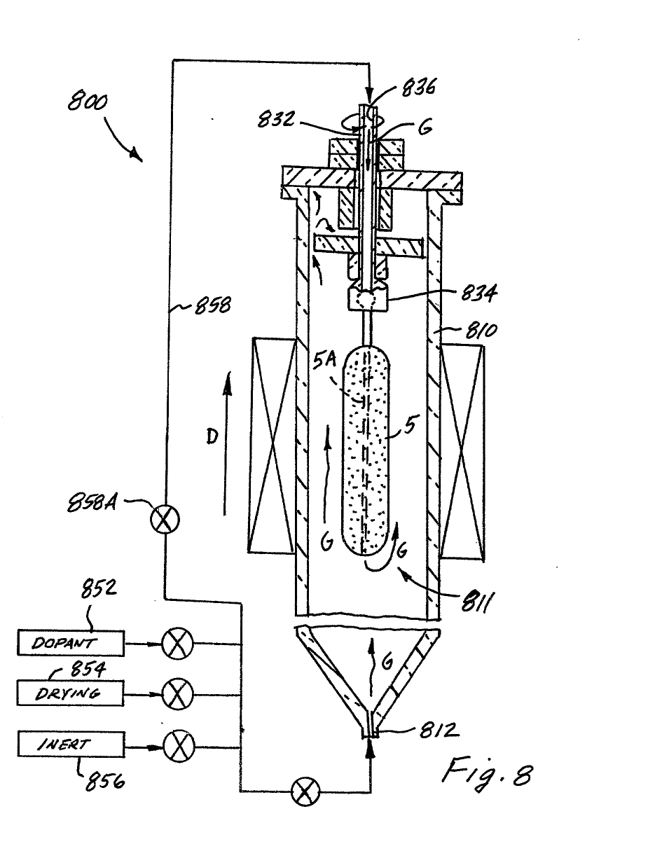

With reference to FIG. 8, a furnace assembly 800 according to further embodiments of the present invention is shown therein. The furnace assembly 800 corresponds to the furnace assembly 300 except as follows. The flow shield collar 370 is omitted. A handle passage 836 extends through the handle body 832 and the coupling portion 834. The gas supplies 852, 854, 856 are each fluidly connected to the handle passage 836 by a line 858. By opening the valve 858A, the process gas G supplied through the inlet opening 812 may also be supplied through the handle passage 836. This portion of the process gas G flows down through the handle passage 836 and through a passage 5A in preform 5. The process gas G exits the passage 5A at the lower end of the preform 5 and, along with the portion of the process gas introduced through the inlet opening 812, flows up the passage 811 and out of the muffle 810. This apparatus and process may be particularly advantageous for drying (e.g., with chlorine).

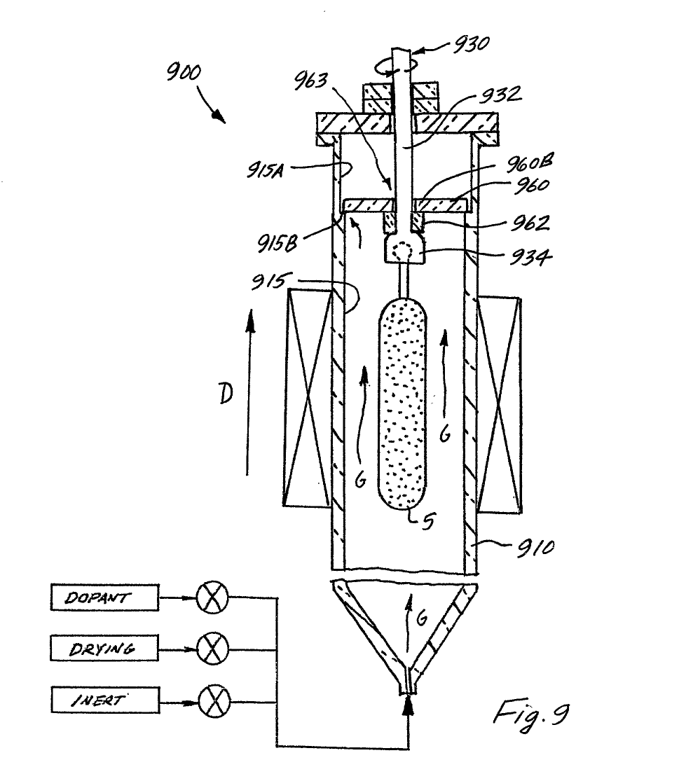

With reference to FIG. 9, a furnace assembly 900 according to further embodiments of the present invention is shown therein. The furnace assembly 900 corresponds to the furnace assembly 100 except as follows. The inner surface 915 of the muffle 910 includes a recessed upper portion 915A which forms an annular ledge 915B. The flow shield 960 has a central opening 960B that is sized and shaped to define an annular restrictive flow passage 963 between the flow shield 960 and the handle body 932.

In use, the handle 930 is lowered until the flow shield 960 rests on the ledge 915B. The handle 930 may be rotated to rotate the preform 5. The restrictive flow passage 963 allows the handle 930 to be rotated without rotating the flow shield 960. The process gas G may flow upwardly between the flow shield 960 and the ledge 915B and/or through the restrictive flow passage 963.

As discussed above, the furnace assemblies 100-900 according to embodiments of the present invention shield the preform 5 from ambient air while requiring a reduced flow of process gas (e.g., dopant gas, drying gas or inert or other purging gases). The reduced flow rate reduces the amount of gas required for the process as well as the amount of exhaust gas which must be scrubbed, recycled or otherwise handled. The reduced flow rate may allow increased reacting time and thereby improved doping and/or cleaning. For example, a process gas including chlorine may be used while drying, cleaning, doping, and/or sintering. A reduced flow rate of the chlorine-containing process gas may be used during the sintering step to allow improved doping and/or cleaning. Preferably the flow rate of the chlorine-containing process gas while sintering is less than 30 slpm, more preferably less than 20 slpm, and most preferably less than 10 slpm.

Various aspects and features of the furnace assemblies 100-900 may be combined. For example, the furnace assembly 200 may be provided with a handle passage, gas openings and supply lines corresponding to the passage 636, the gas openings 638 and the line 658. The flow shield collar 780 may be used in combination with a flow shield attached to the handle (e.g., corresponding to the flow shield 160) or a flow shield attached to the top plate 720 (e.g., corresponding to the flow shield 500). Moreover, while reference is made herein to a “top” plate, upper and lower ends and chambers, upward and downward directions and flows, and the like, the furnace assemblies 100-900 may be reoriented.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention. Therefore, it is to be understood that the foregoing is illustrative of the present invention and is not to be construed as limited to the specific embodiments disclosed, and that modifications to the disclosed embodiments, as well as other embodiments, are intended to be included within the scope of the invention.

What is claimed is:

1. A furnace assembly for heating an optical waveguide preform, the furnace assembly comprising:
a furnace including:
a muffle defining a furnace passage, the furnace passage having a length extending from a first end to a second end; and
a heating device operative to heat the furnace passage;
a process gas supply providing a process gas to the furnace passage;
a handle disposed in the furnace passage and adapted to hold the waveguide preform; and
a flow shield positioned between the first and second ends and extending across the furnace passage between the handle and the muffle, the flow shield arranged and configured to restrict flow of the process gas from the first end to the second end of the furnace passage.

2. The furnace assembly of claim 1 wherein the flow shield defines an isolation chamber between the flow shield and the second end.

3. The furnace assembly of claim 1 wherein the flow shield has a peripheral edge adjacent the muffle, and the peripheral edge and the muffle define a marginal gap therebetween having a width of between about 2.5 mm and 25 mm.

4. The furnace assembly of claim 1 wherein the flow shield has a thickness greater than about 6 mm.

5. The furnace assembly of claim 1 wherein:
the handle extends through a top plate at the second end of the passage; and
the flow shield is disposed between an end of the preform and the top plate.

6. The furnace assembly of claim 1 wherein the flow shield is coupled to the handle.

7. The furnace assembly of claim 1 wherein the handle includes a coupling portion to which the preform is attached and a spacer longitudinally separating the flow shield from the coupling portion.

8. The furnace assembly of claim 7 wherein the spacer separates the flow shield from the preform a distance of at least 50 mm.

9. The furnace assembly of claim 1 wherein the flow shield is formed of at least one material selected from the group consisting of fused silica, fused quartz, ceramic, silicon carbide, ceramic coated fused silica, and ceramic coated fused quartz, and combinations thereof.

10. The furnace assembly of claim 1 wherein the handle is formed of at least one material selected from the group consisting of fused silica, fused quartz, ceramic, ceramic coated fused silica, and ceramic coated fused quartz, and combinations thereof.

11. The furnace assembly of claim 1 wherein the furnace is a waveguide preform holding furnace.

12. The furnace assembly of claim 1 wherein the furnace is a waveguide preform consolidation furnace.

13. The furnace assembly of claim 1 further comprising a second flow shield extending across the furnace passage between the handle and the muffle, the first and second flow shields being arranged and configured to restrict flow of the process gas from the first end to the second end, wherein the second flow shield is spaced apart from the first flow shield along the length of the furnace passage.

14. The furnace assembly of claim 13 including a spacer positioned between the first and second flow shields.

15. The furnace assembly of claim 1 further comprising a second flow shield extending across the furnace passage between the handle and the muffle, the first and second flow shields being arranged and configured to restrict flow of the process gas from the first end to the second end, wherein the second flow shield is located substantially immediately adjacent the first flow shield.

16. The furnace assembly of claim 1 wherein:
the furnace includes an end wall;
the flow shield is spaced apart from the end wall and connected thereto by at least one connecting member; and
the handle is free to move relative to the flow shield.

17. The furnace assembly of claim 1 including a longitudinally extending shield collar extending from the flow shield toward one of the first and second ends, the shield collar including an outer surface facing the muffle, wherein the outer surface and the muffle define a lengthwise restrictive flow passage therebetween.

18. The furnace assembly of claim 17 wherein the restrictive flow passage has a gap dimension between the outer face and the muffle of between about 2.5 and 25 mm.

19. The furnace assembly of claim 17 wherein the restrictive passage has a length of between about 25 and 250 mm.

20. The furnace assembly of claim 17 including a longitudinally extending second shield collar disposed within the first shield collar and including an inner surface facing the handle, wherein the inner surface and the handle define a lengthwise second restrictive passage therebetween.

21. The furnace assembly of claim 20 wherein the second restrictive passage has a gap width between the inner surface and the handle of between about 1 and 20 mm.

22. The furnace assembly of claim 20 wherein the second restrictive passage has a length of between about 25 and 250 mm.

23. The furnace assembly of claim 20 wherein:
the furnace includes an end wall and an exit opening defined in the end wall;
the handle extends through the exit opening; and
the second shield collar extends from the end wall into the furnace passage and surrounds the exit opening.

24. The furnace assembly of claim 1 wherein:
the furnace includes an end wall and an exit opening defined in the end wall; and
the flow shield comprises a shield collar extending from the end wall into the furnace passage and surrounding the exit opening.

25. The furnace assembly of claim 24 wherein the shield collar forms a lengthwise restrictive flow passage with at least one of the muffle and the handle.

26. The furnace assembly of claim 25 wherein the handle extends through the exit opening and the shield collar and the muffle define a first lengthwise restrictive flow passage therebetween and the shield collar and the handle define a second lengthwise restrictive flow passage therebetween.

27. The furnace assembly of claim 1 wherein:
the furnace includes an end wall and an exit opening defined in the end wall;
the handle extends through the exit opening; and
the furnace assembly further includes a washer slidably mounted about the handle and covering a portion of the exit opening.

28. The furnace assembly of claim 27 including a plurality of washers slidably mounted about the handle and covering the portion of the exit opening.

29. The furnace assembly of claim 1 including:
a supply of a second process gas; and
a gas port in fluid communication with the second process gas supply and positioned to direct the second process gas into the furnace passage adjacent a side of the flow shield opposite the preform.

30. The furnace assembly of claim 29 wherein the first and second process gases are the same.

31. The furnace assembly of claim 30 wherein the first and second process gas supplies are the same.

32. The furnace assembly of claim 29 wherein the second process gas is selected from the group consisting of Ar, He, and N₂, and mixtures thereof.

33. The furnace assembly of claim 29 wherein the gas port is formed in the handle, the handle further comprising a handle passage extending through the handle and fluidly connecting the second process gas supply and the gas port.

34. The furnace assembly of claim 33 further comprising a second flow shield extending across the furnace passage between the handle and the muffle, the first and second flow shields being arranged and configured to restrict flow of the first process gas from the first end to the second end, wherein:
the second flow shield is spaced apart from the first flow shield along the length of the furnace passage; and
the gas port is positioned between the first and second flow shields.

35. The furnace assembly of claim 1 including a processing gas port in fluid communication with the process gas supply and positioned to direct the process gas into the furnace passage adjacent a side of the flow shield closest to the preform.

36. The furnace assembly of claim 1 wherein the handle is free to move relative to the flow shield and the muffle includes a ledge adapted to support the flow shield.

37. The furnace assembly of claim 35 wherein the process gas is selected from the group consisting of Cl₂, SiF₄, CF₄, SF₆, NF₃, GeCl₄, SiCl₄, POCl₃, BCl₃, BF₃, PCl₃, C₂F₆, and CO, and mixtures thereof.

38. The furnace assembly of claim 1 wherein the handle is movable relative to the muffle and the flow shield is mounted on the handle for movement therewith.

39. The furnace assembly of claim 38 including a drive assembly operable to translate the handle and the flow shield relative to the muffle.

40. The furnace assembly of claim 38 including a drive assembly operable to rotate the handle and the flow shield relative to the muffle.

41. A furnace assembly adapted to heat an optical fiber preform, comprising:
a muffle tube defining a furnace passage, the passage including a length extending from a first end to a second end,
a process gas supply adapted to supply a process gas in the passage directed from the first end to the second end,
a handle adapted to suspend the preform within the passage, and
a flow shield positioned in the passage between the preform and the second end and extending between the handle and the muffle tube, wherein the flow shield is configured to enable restriction of flow of the process gas.

42. A furnace assembly adapted to heat an optical fiber preform, said assembly comprising:
a muffle tube including a passage;
a top plate mounted on an end of the tube;
a gas supply for supplying process gas to the passage;
a handle traversing the top plate and adapted to suspend the preform in the passage; and
a flow shield positioned in the passage between the preform and the top plate, wherein the flow shield is configured to enable restriction of the gas.

43. A flow restrictor assembly for an optical fiber furnace adapted to heat an optical fiber preform, the assembly comprising:
a top plate having a passage of a first dimension formed therethrough;
at least one solid flow restrictor having a hole of a second dimension formed therethrough; and
a handle inserted through the passage and the hole, the handle adapted to suspend the preform wherein the first dimension is larger than the second dimension.

44. A method of manufacturing an optical fiber preform, comprising the steps of:
flowing a process gas in a furnace passage of a muffle tube from a first end to a second end, the furnace passage having the optical fiber preform mounted therein, and
restricting flow of the process gas using a flow shield positioned in the passage between the preform and the second end and extending between a handle and the muffle tube.

45. The method of claim 44 wherein the process gas is flowed through the muffle tube at a rate of no more than 30 slpm.

46. The method of claim 44 wherein the process gas is flowed through the muffle tube at a rate of no more than 10 slpm.
